(19) United States
(12) Patent Application Publication
(10) Pub. No.: US 2009/0316070 A1
(43) Pub. Date: Dec. 24, 2009

(54) DISPLAY APPARATUS SWITCHABLE BETWEEN TRANSMISSIVE MODE AND REFLECTIVE MODE

(75) Inventors: Seong-mo HWANG, Seongnam-si (KR); Moon-gyu LEE, Suwon-si (KR); Jee-hong MIN, Seongnam-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/479,309

(22) Filed: Jun. 5, 2009

(30) Foreign Application Priority Data
Jun. 24, 2008 (KR) 10-2008-0059769

(51) Int. Cl. G02F 1/13357

(52) U.S. Cl. 349/62

(57) ABSTRACT

A display apparatus including a plurality of pixels, each of the pixels including a first polarizing plate; a liquid crystal layer disposed under the first polarizing plate; a second polarizing plate, which is reflective and is disposed under and adjacent to the liquid crystal layer; a backlight unit disposed under the second polarizing plate; and a light absorbing layer disposed under the backlight unit, wherein the plurality of pixels can be switched between one of a reflective mode in which an image is displayed using external light and a transmissive mode in which an image is displayed using light irradiated from the backlight unit.

This application claims priority to Korean Patent Application No. 10-2008-0059769, filed on Jun. 24, 2008, and all the benefits accruing therefrom under 35 U.S.C. § 119, the contents of which in its entirety are herein incorporated by reference.

### BACKGROUND OF THE INVENTION

1. Field of the Invention

This disclosure relates to a display apparatus, which is switchable between a transmissive mode and a reflective mode.

2. Description of the Related Art

Recent developments in communication technologies and display apparatuses have enabled development of various types of portable multimedia devices. Exemplary portable multimedia devices include personal digital assistants (“PDA”s), portable multimedia players (“PMP”s), digital multimedia broadcasting (“DMB”) devices, or the like. A liquid crystal display (“LCD”) device, which is a type of a non-emissive flat panel display device, can be used in the portable multimedia devices, which do not emit light, by controlling a transmissivity of light irradiated from a light source at each pixel. Accordingly, a backlight unit, which irradiates light, can be disposed in the back of an LCD device.

A feature of a portable multimedia device is that they can be used anywhere, including outside in sunlight. In sunlight, however, a visibility of an image displayed on a display unit can be reduced because a brightness of a display unit is dark relative to that of sunlight. Therefore, an advantage of the portable multimedia device, specifically its ability to be used anywhere, can be lost. Furthermore, if an LCD device is to be employed in an outdoor billboard or in a display device used in a brightly lit public location, it is desirable for the LCD device to always have sufficient visibility. For application in brightly lit conditions, a transreflective display device, which operates in both a reflective mode, using external light, and a transmissive mode, using a backlight unit, has been developed. However, in a current transreflective display device, a region for the reflective mode is separate from a region for the transmissive mode, and one pixel is divided into two regions. Thus, in the current transreflective display device, a total resolution, which is a sum of the transmissive mode resolution and reflective mode resolution, may be reduced, and maximum brightness may be difficult to achieve in each mode.

### BRIEF SUMMARY OF THE INVENTION

Disclosed is a display apparatus having a reflective mode, which uses external light, and a transmissive mode, which uses light from a backlight unit, wherein the reflective mode and the transmissive mode can occur using substantially an entire liquid crystal cell without dividing the liquid crystal cell.

The above described and other drawbacks are alleviated by a display apparatus including a plurality of pixels, each of the pixels including a first substrate; a first polarizing plate on the first substrate; a second substrate; a liquid crystal layer disposed between the first substrate and the second substrate; a second polarizing plate which is disposed between the first substrate and the second substrate, reflecting and transmitting external light or internal light; a backlight unit irradiating the internal light and disposed under the second polarizing plate; and a light absorbing layer disposed under the backlight unit, wherein the plurality of pixels can be switched between one of a reflective mode in which an image is displayed using the external light and a transmissive mode in which an image is displayed using the internal light.

In an embodiment, a diffusing plate is disposed on the first polarizing plate.

In an embodiment, the diffusing plate contacts the first polarizing plate without any air layer interposed therebetween.

In an embodiment, an anti-reflection layer is further disposed on the diffusing plate.

In an embodiment, the second polarizing plate is disposed within the liquid crystal layer and within a cell structure.

In an embodiment, the display apparatus further includes a quarter wavelength plate disposed between the second polarizing plate and the backlight unit.

In an embodiment, the display apparatus further includes a reflective third polarizing plate disposed between the backlight unit and the light absorbing layer.

In an embodiment, the display apparatus further includes a switching mirror between the backlight unit and the light absorbing layer.

In an embodiment, the display apparatus further includes a polarization converting layer disposed between the backlight unit and the switching mirror.

In an embodiment, the display apparatus further includes a first color filter layer disposed between the first polarizing plate and the liquid crystal layer; and a second color filter layer disposed under the second polarizing plate.

In an embodiment, the diffusing plate has a haze value with respect to oblique incident light, which is greater than a haze value with respect to front incident light.

In an embodiment, the backlight unit irradiates focused light, wherein a brightness at full width at half maximum is plus or minus 20 degrees.

Also disclosed is a pixel, including: a first substrate; a first polarizing plate on the first substrate; a second substrate; a liquid crystal layer disposed between the first substrate and the second substrate; a second polarizing plate which is disposed between the first substrate and the second substrate, reflecting and transmitting external light or internal light; a backlight unit irradiating the internal light and disposed under the second polarizing plate; and a light absorbing layer disposed under the backlight unit, wherein the pixel can be switched between one of a reflective mode in which the external light is reflected by the second polarization plate and a transmissive mode in which the internal light is transmitted through the second polarization plate.

In an embodiment, the liquid crystal layer electrically controls a transmissivity of incident light.

In an embodiment, the reflective mode includes display of an image using external light.

In an embodiment, the transmissive mode includes display of an image using light irradiated from the backlight unit.

In an embodiment, the display apparatus can be switched between a reflective mode and a transmissive mode.

Also disclosed is a method of displaying an image, the method including: passing light through a first polarizing plate to form a first light having a first polarization; selectively converting the first light having the first polarization to a second light having a second polarization; reflecting the first light from a second polarizing plate if it has the first polarization; and transmitting the second light having the second polarization through the second polarizing plate if the first light is converted to the second light having the second polarization.

In an embodiment, the disclosed diffusing plate can have a haze values with respect to oblique incident light, which is greater than a haze value with respect to front incident light.

These and other features, aspects, and advantages of the disclosed embodiments will become better understood with reference to the following description and appended claims.

### BRIEF DESCRIPTION OF THE DRAWINGS

The disclosed subject matter is particularly pointed out and distinctly claimed in the claims at the conclusion of the specification. The above and other, aspects, features, and advantages of the disclosed embodiments are apparent from the following detailed description taken in conjunction with the accompanying drawings in which:

FIG. 1 is a cross-sectional diagram showing an exemplary embodiment of a pixel in a display apparatus;

FIG. 2A shows an exemplary embodiment of a method of displaying a white color in a reflective mode of the display apparatus of FIG. 1;

FIG. 2B shows an exemplary embodiment of a method of displaying a black color in the reflective mode of the display apparatus of FIG. 1;

FIG. 3A shows an exemplary embodiment of a method of displaying a black color in a transmissive mode of the display apparatus of FIG. 1;

FIG. 3B shows an exemplary embodiment of a method of displaying a white color in the transmissive mode of the display apparatus of FIG. 1;

FIG. 4A shows an exemplary embodiment of a method of displaying a white color in a reflective mode of a display apparatus according to another exemplary embodiment;

FIG. 4B shows an exemplary embodiment of a method of displaying a black color in the reflective mode of the display apparatus of FIG. 4A;

FIG. 5 is a cross-sectional diagram of an exemplary embodiment of a display apparatus according to another exemplary embodiment;

FIG. 6A shows an exemplary embodiment of a method of displaying a white color in the reflective mode of the display apparatus of FIG. 5;

FIG. 6B shows an exemplary embodiment of a method of displaying a black color in a reflective mode of the display apparatus of FIG. 5;

FIG. 7A shows an exemplary embodiment of a method of displaying a black color in a transmissive mode of the display apparatus of FIG. 5;

FIG. 7B shows an exemplary embodiment of a method of displaying a white color in the transmissive mode of the display apparatus of FIG. 5;

FIG. 8 is a cross-sectional diagram of an exemplary embodiment of a display apparatus;

FIG. 9 is a cross-sectional diagram further illustrating the display apparatus of FIG. 5, including a color filter for display of a colored image;

FIG. 10 is a cross-sectional diagram of an exemplary embodiment of a display apparatus according to another exemplary embodiment;

FIG. 11 is a cross-sectional diagram of another exemplary embodiment of a display apparatus;

FIG. 12A shows an exemplary embodiment of a method of displaying a white color in a transmissive mode of the display apparatus of FIG. 11; and

FIG. 12B shows an exemplary embodiment of a method of obtaining a black color in a reflective mode of the display apparatus of FIG. 11.

### DETAILED DESCRIPTION OF THE INVENTION

Aspects, advantages, and features of the present invention and methods of accomplishing the same may be understood more readily by reference to the following detailed description of preferred embodiments and the accompanying drawings. The present invention may, however, may be embodied in many different forms, and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer, or section from another region, layer or section. Thus, a first element, component, region, layer, or section discussed below could be termed a second element, component, region, layer, or section without departing from the teachings of the present invention.

Spatially relative terms, such as “below”, “lower”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “lower” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings. However, the aspects, features, and advantages of the present invention are not restricted to the ones set forth herein. The above and other aspects, features and advantages of the present invention will become more apparent to one of ordinary skill in the art to which the present invention pertains by referencing a detailed description of the present invention given below.

Hereinafter, a display apparatus, which can be switched between a transmissive mode and a reflective mode, is described in detail with reference to the attached drawings.

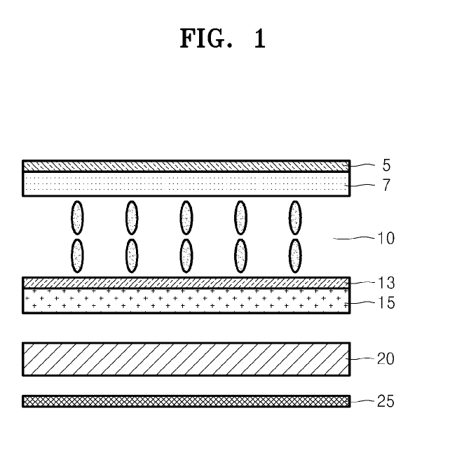

FIG. 1 is a cross-sectional diagram showing an exemplary embodiment of a pixel in a display apparatus, wherein a plurality of pixels can be disposed in a matrix configuration. A display apparatus according to an embodiment includes a first polarizing plate 5, a liquid crystal layer 10, a second polarizing plate 13, which is a reflective type polarizing plate, a backlight unit 20, and a light absorbing layer 25. According to an embodiment, an entire region of each of the pixels can operate in a reflective mode for display of an image using external light, and a transmissive mode for display of an image using light emitted from the backlight unit 20. In an embodiment, a pixel is not divided into a region for the reflective mode and a region for the transmissive region.

The first polarizing plate 5 is an absorbing type. Thus the first polarizing plate 5 transmits light of a first polarization and absorbs light of a second polarization, which is perpendicular to the first polarization. The liquid crystal layer 10 selects a transmissivity of light according to a magnitude of an applied voltage. The liquid crystal layer 10 may comprise a twisted nematic (“TW”) liquid crystal, a vertical alignment (“VA”) liquid crystal, or an electrically controlled birefringence (“ECB”) liquid crystal. The liquid crystal layer 10 is disposed between a first substrate 7 and a second substrate 15, and the second polarizing plate 13 may be disposed within the liquid crystal layer 10 within a cell structure. The first substrate 7 and the second substrate 15 may be transparent. Within a cell structure, the second polarizing plate 13 is disposed within a liquid crystal layer at an upper portion of the second transparent substrate 15. Accordingly, if the second polarizing plate 13 is disposed within the cell structure, a path along which light modulated in a liquid crystal layer passes is shortened as compared to an embodiment in which the second polarizing plate 13 is disposed outside the liquid crystal layer. Thus, parallax caused as an image is transmitted to an adjacent pixel in the reflective mode can be minimized. The second polarizing plate 13 is a reflective type and reflects light of the first polarization and transmits light of the second polarization.

A liquid crystal display (“LCD”) device, which is a type of a non-emissive flat panel display device used in portable multimedia devices, cannot emit light by itself, and thus it is desirable for an LCD device to have a separate light source. A display device using an LCD device forms an image by controlling a transmissivity of light irradiated from a light source at each of a plurality of pixels. The light source can be a backlight unit 20, and can be disposed in a back of the LCD device. In an embodiment, an image can be formed using either light from the backlight unit 20 or external light. Backlight units may be classified as a direct light type, or an edge light type, according to an arrangement of a light source. The direct light type refers to a structure in which a lamp is disposed directly below a liquid crystal panel and irradiates light directly onto the liquid crystal panel, whereas the edge light type refers to a structure in which light is irradiated onto the liquid crystal panel via a light guide plate. A display device can employ both types of backlight units. The backlight unit 20 can be designed to irradiate collimated light to reduce or substantially prevent leakage of oblique incident light in a liquid crystal layer. The backlight unit 20 irradiates focused light having a brightness at full width at half maximum (“FWHM”) of plus or minus (“±”) 30 degrees (“°”), specifically ±20°, more specifically ±10°. A liquid crystal layer can allow leakage of oblique incident light. Thus, collimating the oblique incident light can reduce leakage of oblique incident light in the liquid crystal layer, and thus a contrast ratio (“CR”) characteristic of the display device in the transmissive mode can be improved by irradiating collimated light. A light absorbing layer 25 is disposed below the backlight unit 20.

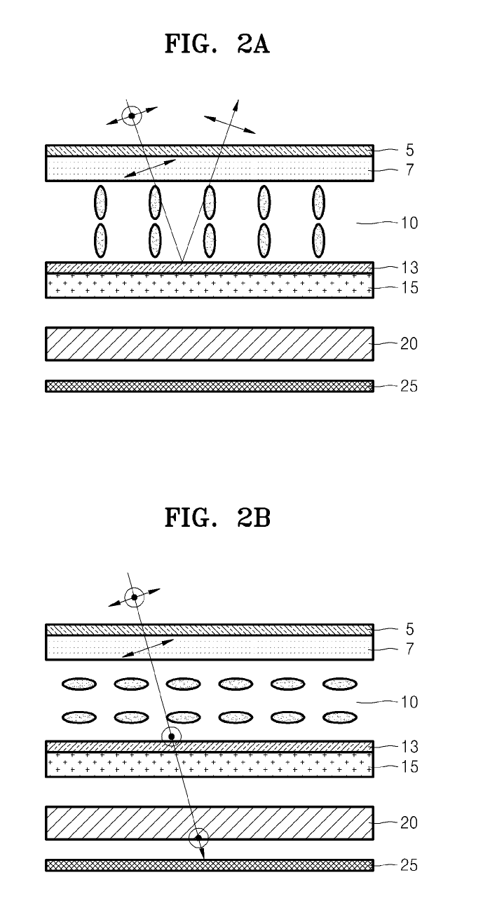

A method of operation of a display device according to an embodiment is described in an embodiment comprising a vertical alignment (“VA”) liquid crystal mode in a default VA state. FIGS. 2A and 2B show an exemplary embodiment of a method of operation in the reflective mode. FIG. 2A shows an exemplary embodiment of a method operation in which a white color is displayed using external light, wherein a voltage is not applied to the liquid crystal layer 10. A path of light is shown in the figures using a single-headed arrow, and a double-headed arrow indicates a polarization of the light. When unpolarized external light passes through the first polarizing plate 5, only light of a first polarization is transmitted. When a voltage is not applied to the liquid crystal layer 10, the liquid crystal layer 10 does not exhibit a phase delay. Thus, when light of the first polarization is incident onto the liquid crystal layer 10, the light of the first polarization is also incident onto the second polarizing plate 13 without the phase delay. The light of the first polarization is reflected by the second polarizing plate 13, travels through the liquid crystal layer 10, and is incident onto the first polarizing plate 5 again. The light of the first polarization is transmitted in an outward direction through the first polarizing plate 5 and forms a white color. FIG. 2B shows an exemplary embodiment of a method of operation in which a black color is displayed in the reflective mode. First, a voltage is applied to the liquid crystal layer 10. When unpolarized external light passes through the first polarizing plate 5, only light of the first polarization is transmitted and a phase delay of a ½ wavelength occurs in the liquid crystal layer 10 to which the voltage is applied. Thus, the light of the first polarization is converted to light of the second polarization in the liquid crystal layer 10 and is incident onto the second polarizing plate 13. The second polarizing plate 13 transmits light of the second polarization. Thus, the light of the second polarization passes through the second polarizing plate 13 and the backlight unit 20, and is absorbed by the light absorbing layer 25. Thus, the black color is displayed when a voltage is applied to the liquid crystal layer 10.

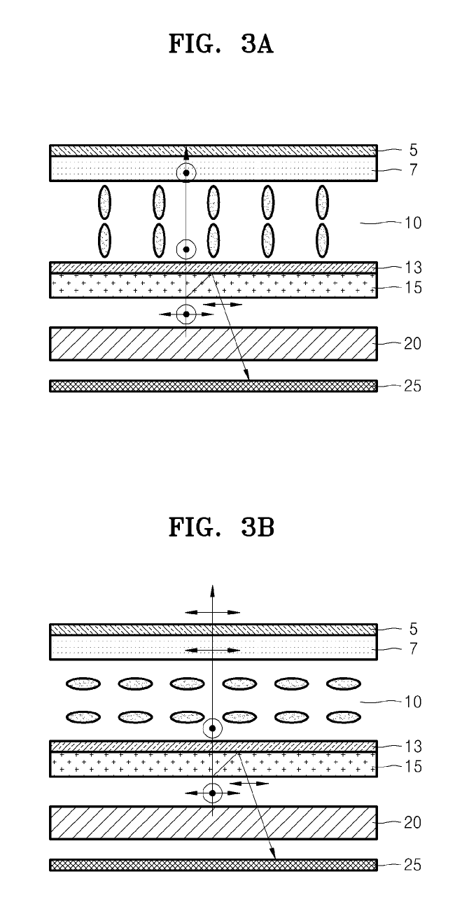

FIGS. 3A and 3B show an exemplary embodiment of a method of operation in the transmissive mode. FIG. 3A shows an exemplary embodiment of a method of operation in which a black color is displayed using the light irradiated from the backlight unit 20. In an embodiment, a voltage is not applied to the liquid crystal layer 10. Unpolarized light irradiated from the backlight unit 20 is incident onto the second polarizing plate 13. At this point, light of the first polarization is reflected by the second polarizing plate 13, whereas light of the second polarization is transmitted and is incident onto the liquid crystal layer 10. The light of the first polarization, reflected by the second polarizing plate 13, passes through the backlight unit 20 and is absorbed by the light absorbing layer 25, whereas the light of the second polarization, which is incident on the liquid crystal layer 10, undergoes no phase delay in the liquid crystal layer 10, and thus is incident onto the first polarizing plate 5 without change in a polarization direction. Thus, light of the second polarization is absorbed by the first polarizing plate 5, and thus a black color is displayed. FIG. 3B shows an operation in which a white color is displayed by using light irradiated from the backlight unit 20. In an embodiment, a voltage is applied to the liquid crystal layer 10. Unpolarized light irradiated from the backlight unit 20 is incident onto the second polarizing plate 13. At this point, light of the first polarization is reflected by the second polarizing plate 13, whereas light of the second polarization is transmitted and is incident onto the liquid crystal layer 10. The light of the first polarization reflected by the second polarizing plate 13 passes through the backlight unit 20 and is absorbed by the light absorbing layer 25, whereas the light of the second polarization incident onto the liquid crystal layer 10 undergoes a phase delay of a ½ wavelength in the liquid crystal layer 10, and thus is converted to light of the first polarization, and is incident onto the first polarizing plate 5. The light of the first polarization passes through the first polarizing plate 5, is output in outward direction, and a white color is displayed.

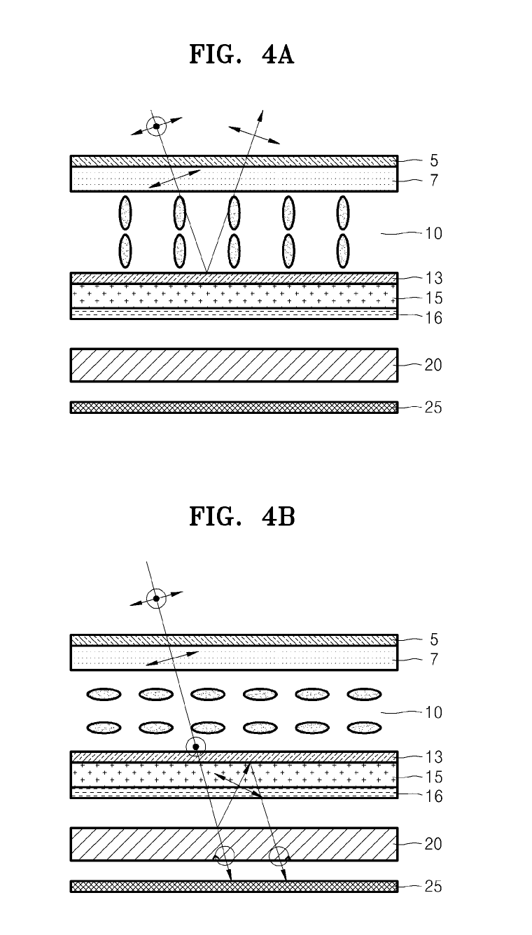

FIG. 4A is a diagram illustrating an exemplary embodiment in which a quarter (“¼”) wavelength plate 16 is further disposed between the second transparent substrate 15 and the backlight unit 20. The ¼ wavelength plate 16 can increase the CR in the reflective mode. FIG. 4A shows an exemplary embodiment of a method of operation in which a white color is displayed in a reflective mode. When unpolarized external light passes through the first polarizing plate 5, light of a first polarization is transmitted and is incident onto the liquid crystal layer 10. When a voltage is not applied to the liquid crystal layer 10, the light of the first polarization does not undergo a phase delay, is reflected by the second polarizing plate 13, passes through the liquid crystal layer 10, the first transparent substrate 7, and the first polarizing plate 5, and is output in an outward direction. FIG. 4B shows an exemplary embodiment of a method of operation in which a black color is displayed in the reflective mode. Circular polarization is indicated by a circular arrow. When unpolarized external light passes through the first polarizing plate 5, only light of the first polarization is incident onto the liquid crystal layer 10, and the light of the first polarization is converted to light of a second polarization in the liquid crystal layer 10, to which a voltage is applied, and passes through the second polarizing plate 13. The light of the second polarization is converted to light of a first circular polarization in the ¼ wavelength plate 16 and is incident onto the backlight unit 20. Part of the incident light passes through the backlight unit 20 and is absorbed by the light absorbing layer 25, whereas the other part of the incident light may be reflected by an optical film, a light guide plate, or the like, in the backlight unit 20 and may return in an upward direction. Light reflected in the upward direction is converted to light of the first polarization in the ¼ wavelength plate 16. The light of the first polarization is reflected by the second polarizing plate 13, passes through the backlight unit 20, and is absorbed by the light absorbing layer 25. Accordingly, the CR characteristic can be improved by using the ¼ wavelength plate 16 to block light, which may be reflected by the backlight unit 20, and output in an outward direction. The ¼ wavelength plate has substantially no effect in the transmissive mode, and thus a detailed description thereof will be omitted.

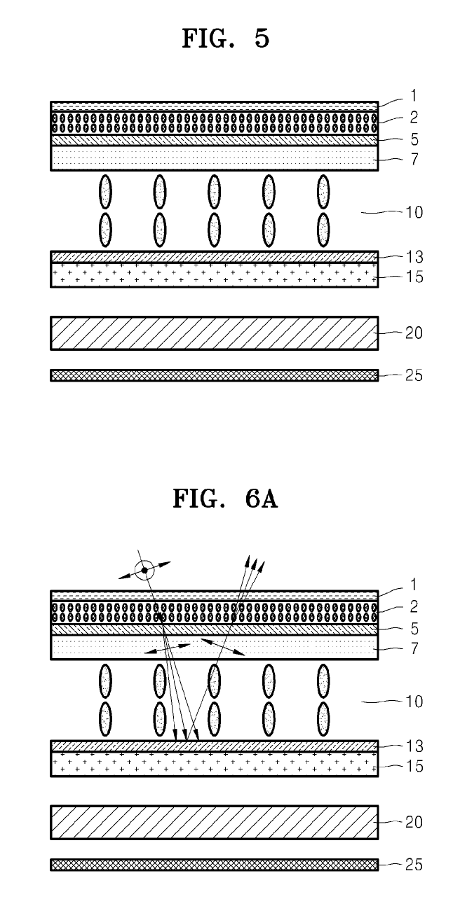

FIG. 5 is a diagram illustrating an exemplary embodiment in which a diffusing plate 2 is disposed on the first polarizing plate 5 in the display device described with respect to FIG. 1. The diffusing plate 2 diffuses light when the light is output in an outward direction to obtain a sufficient viewing angle, for example. Furthermore, the diffusing plate 2 and the first polarizing plate 5 may be disposed as a single unitary body without an air layer therebetween. In an embodiment, the transmissivity and CR with respect to an external light can be improved as compared to an embodiment in which a diffusing plate and a polarizing plate are disposed separately. Thus, in an embodiment, the polarizing plate and the diffusing plate are disposed as a single unitary body and can reduce an interface between the polarizing plate and the diffusing plate so that an intensity of reflected external light is reduced. Thus, an external visibility can be increased. Furthermore, when the first polarizing plate 5 and the diffusing plate 2 are disposed as the single unitary body, an intensity of transmitted external light can be increased. Thus, an intensity of light reflected by the second polarizing plate 13 and output in outward direction can be increased. An anti-reflection layer 1 may further be disposed on the diffusing plate 2 to reduce or substantially prevent a reduction in a visibility due to reflection of external light.

In an embodiment, external light incident at an angle of about 30° with respect to a screen can be used in the reflective mode. In the reflective mode, light passes through the diffusing plate 2 twice, and thus high resolution images may partially overlap each other. To reduce or substantially prevent an image overlap, the diffusing plate 2 can be disposed so that a haze is small with respect to oblique incident light. Haze is a ratio of diffused light with respect to transmitted light. Thus the diffusing plate 2 can be disposed so that oblique incident light, which is generally used in the reflective mode, is not scattered significantly when the oblique incident light passes through the diffusing plate 2. Therefore, the image overlap can be reduced. In contrast, collimated light, which is irradiated from the backlight unit 20 and is incident directly onto the diffusing plate 2, can be used in the transmissive mode, and it is desirable to significantly scatter such front incident light to widen the viewing angle. Therefore, the diffusing plate 2 can have a large haze with respect to front incident light in the transmissive mode. Accordingly, disposing a diffusing plate 2, wherein a haze is different for different angles of incident light, can result in a higher intensity of transmitted light and an improved viewing angle in both the reflective mode and the transmissive mode.

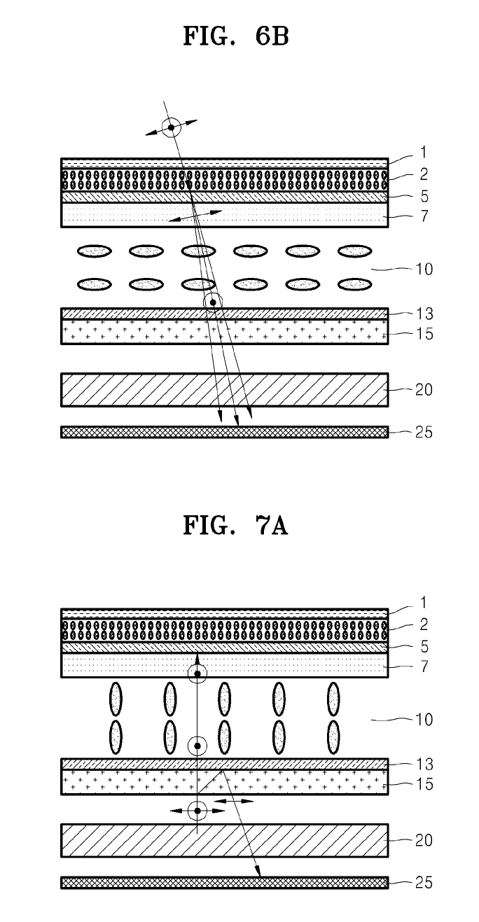

FIGS. 6A and 6B are diagrams illustrating an exemplary embodiment of a method of operation of the display apparatus shown in FIG. 5 in the reflective mode. FIG. 6A illustrates an exemplary embodiment of a method operation in which a white color is displayed using external light. In an embodiment, a voltage is not applied to the liquid crystal layer 10. Unpolarized external light passes through the anti-reflection layer 1 and the diffusing layer 2, and is incident onto the first polarizing plate 5. When the unpolarized external light passes through the first polarizing plate 5, only light of a first polarization is transmitted. When a voltage is not applied to the liquid crystal layer 10, the liquid crystal layer 10 does not exhibit a phase delay. Thus, when light of the first polarization is incident onto the liquid crystal layer 10, the light of the first polarization is incident onto the second polarizing plate 13 without a phase delay. The light of the first polarization is reflected by the second polarizing plate 13, passes through the liquid crystal layer 10, and is incident onto the first polarizing plate 5. The light of the first polarization passes through the first polarizing plate 5, is output in an outward direction to the outside, and forms white color. FIG. 6B illustrates an exemplary embodiment of a method of displaying a black color in the reflective mode. In an embodiment, a voltage is applied to the liquid crystal layer 10. Unpolarized external light passes through the anti-reflection layer 1 and the diffusing layer 2, is incident onto the first polarizing plate 5, and only light of the first polarization is transmitted. The light of the first polarization is converted to light of a second polarization in the liquid crystal layer 10, to which a voltage is applied, and is incident onto the second polarizing plate 13. Since the second polarizing plate 13 transmits light of the second polarization, the light of the second polarization is transmitted through the second polarizing plate 13, passes through the backlight unit 20, and is absorbed by the light absorbing layer 25. Thus, a black color is displayed when a voltage is applied to the liquid crystal layer 10.

FIGS. 7A and 7B are diagrams illustrating an exemplary embodiment of a method of operation of the display apparatus shown in FIG. 5 in the transmissive mode. FIG. 7A illustrates an exemplary embodiment of a method of displaying a black color using light irradiated from the backlight unit 20. In an embodiment, a voltage is not applied to the liquid crystal layer 10. Unpolarized light irradiated from the backlight unit 20 is incident onto the second polarizing plate 13. Light of a first polarization is reflected by the second polarizing plate 13, whereas light of a second polarization is transmitted through the second polarizing plate 13 and is incident onto the liquid crystal layer 10. The reflected light of the first polarization passes through the backlight unit 20 and is absorbed by the light absorbing layer 25. Also, the light of the second polarization incident onto the liquid crystal layer 10 is incident onto the first polarizing plate 5 without a change in a polarization direction because the liquid crystal layer 10 does not exhibit a phase delay. Thus, the light of the second polarization is absorbed by the first polarizing plate 5, and thus a black color is displayed. FIG. 7B illustrates an exemplary embodiment of a method of displaying a white color using light irradiated from the backlight unit 20. In an embodiment, a voltage is applied to the liquid crystal layer 10. Unpolarized light irradiated from the backlight unit 20 is incident onto the second polarizing plate 13. Light of the first polarization is reflected by the second polarizing plate 13, whereas light of the second polarization is transmitted through the second polarizing plate 13 and is incident onto the liquid crystal layer 10. The reflected light of the first polarization passes through the backlight unit 20 and is absorbed by the light absorbing layer 25. Also, the light of the second polarization incident to the liquid crystal layer 10 undergoes a phase delay of a ½ wavelength, is converted to light of the first polarization, and is incident onto the first polarizing plate 5. The light of the first polarization passes through the first polarizing plate 5, is diffused by the diffusing plate 2, and is output in an outward direction to the outside. Thus, a white color is displayed. The light having a white color can be sufficiently diffused by the diffusing plate 2 to provide a wide viewing angle.

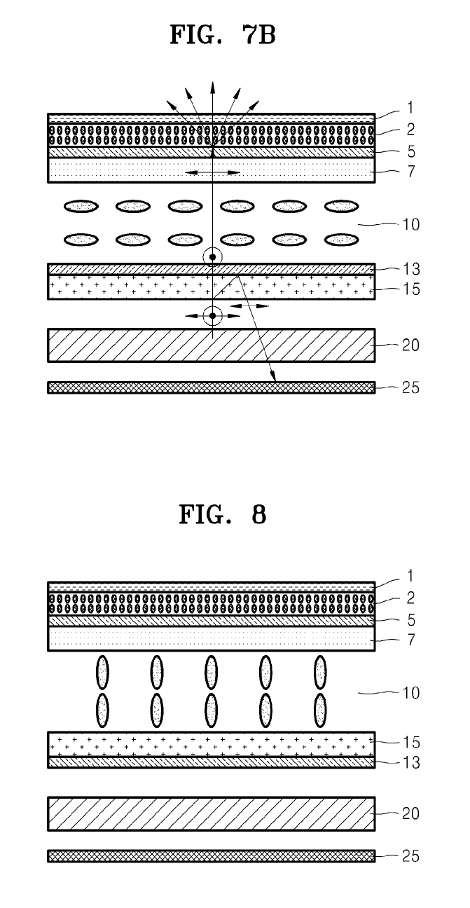

FIG. 8 is a cross-sectional diagram of another exemplary embodiment of a display apparatus. As compared to the structure of FIG. 5, the structure of FIG. 8 is similar to that of FIG. 5 except that the relative positions of the second transparent substrate 15 and the second polarizing plate 13 are changed. The second polarizing plate 13 of FIG. 5 is disposed within the cell structure and within the liquid crystal layer 10 in FIG. 5. The second polarizing plate 13 is disposed under the second transparent substrate 15 in FIG. 8. If the second polarizing plate 13 is disposed under the second transparent substrate 15, the second polarizing plate 13 can be a commercially available reflective polarizer sheet, or the like.

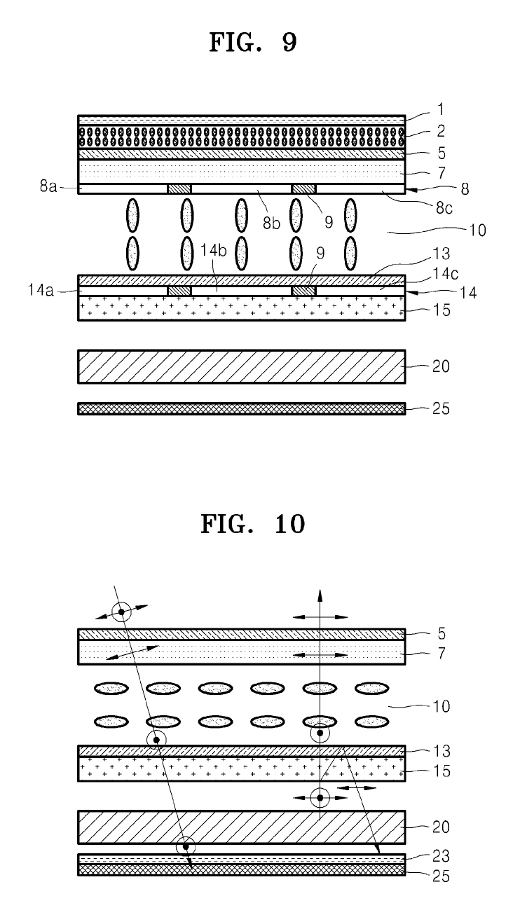

FIG. 9 is a cross-sectional diagram further illustrating the display apparatus of FIG. 5, including a color filter for display of a color. A first color filter layer 8 is disposed under the first transparent substrate 7, and a second color filter layer 14 is disposed between the second polarizing plate 13 and the second transparent substrate 15. The first color filter layer 8 includes a plurality of sub-color filters, including first to third sub-color filters 8a, 8b, and 8c, respectively, which can transmit light having a different color from each other, and black matrixes 9, which are disposed between adjacent sub-color filters to block light from adjacent pixels. The second color filter layer 14 also includes a plurality of sub-color filters, including first to third sub-color filters 14a, 14b, and 14c, respectively. In an embodiment, the display apparatus can include two color filters to eliminate a color difference between the reflective mode and the transmissive mode. Thus, in an embodiment where only one color filter layer is disposed on a liquid crystal layer, a color in the reflective mode and a color in the transmissive mode may be displayed differently because light passes through the color filter layer twice in the reflective mode, whereas light passes through the color filter layer once in the transmissive mode. In an embodiment wherein two color filters are disposed on a liquid crystal layer, light passes through the first color filter 8 twice in the reflective mode, and light passes the second color filter 14 and the first color filter 8 in the transmissive mode. Therefore, a path length of light in the reflective mode and the transmissive mode can be substantially identical to each other, and thus a color difference between the reflective mode and the transmissive mode can be reduced or substantially eliminated. As compared to the display apparatus of FIG. 5, all components of the display apparatus of FIG. 9 other than the color filter layers are substantially identical. Thus, duplicative description is omitted.

FIG. 10 is a cross-sectional diagram illustrating the display apparatus of FIG. 1, further including a third polarizing plate 23, which is a reflective polarizing plate, between the backlight unit 20 and the light absorbing layer 25. The third polarizing plate 23 can improve light efficiency by recycling polarized light reflected by the second polarizing plate 13, wherein the polarized light is part of the light irradiated from the backlight unit 20 in the transmissive mode. In the transmissive mode, light is irradiated from the backlight unit 20. Light of a first polarization is reflected, whereas light of a second polarization is transmitted. The light of the second polarization forms a white color or a black color according to whether a voltage is applied to the liquid crystal layer 10. Light of the first polarization reflected by the second polarizing plate 13 passes the backlight unit 20 and is incident onto the third polarizing plate 23. The backlight unit 20 generally includes a light source, a light guide plate, and various optical films. The light guide plate and the various optical films may become anisotropic during fabrication. Therefore, light of the first polarization is partially converted to light of the second polarization as the light of the first polarization travels between the backlight unit 20 and the third polarizing plate 23, reflecting light of the first polarization. Light of the second polarization is transmitted through the second polarizing plate 23 and is used for displaying an image. Accordingly, partially recycling light reflected by the second polarizing plate 13, by using the reflective third polarizing plate 23, may improve an efficiency of light use, and may result in an improved brightness in the transmissive mode and a reduction of power consumption.

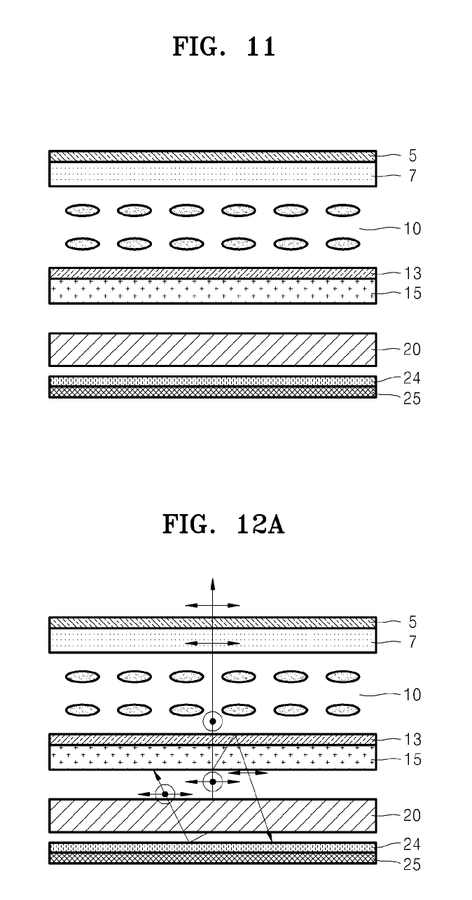

FIG. 11 is a cross-sectional diagram illustrating the display apparatus of FIG. 1 further including a switching mirror 24 disposed between the backlight unit 20 and the light absorbing layer 25. The switching mirror 24 can improve an efficiency of light use by reflecting and recycling light irradiated in rearward direction from the backlight unit 20 in the transmissive mode. The switching mirror 24 reflects light in the transmissive mode, and may be electrically switched to transmit light in the reflective mode. An exemplary configuration and method of operation of the switching mirror 24 may be found in U.S. Pat. No. 6,647,166, which is herein incorporated by reference.

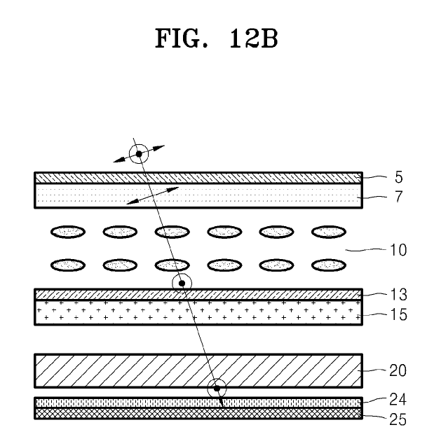

FIG. 12A is a cross-sectional diagram illustrating an exemplary embodiment of a method of operation in which the display apparatus of FIG. 11 displays a white color in the transmissive mode. Light is irradiated from the backlight unit 20 in a frontward direction and a rearward direction. In an embodiment, operational characteristics of light irradiated in the frontward direction are the same as described above. Also, light irradiated in a rearward direction is reflected by the switching mirror 24 and travels in a direction toward the second polarizing plate 13. The method of operation thereafter is the same as that described above in reference to FIGS. 3A and 3B. Therefore, light irradiated from the backlight unit 20 in a frontward direction and a rearward direction may be entirely used, and thus an efficiency of light use can be improved and a brightness improved and a power consumption reduced in the transmissive mode. Furthermore, if either a polarization converting layer or a ¼ wavelength plate (not shown) is further disposed on the switching mirror 24, polarized light reflected by the second polarizing plate 13 can be converted and recycled. Thus, an efficiency of light use can further be improved. The polarization converting layer or the ¼ wavelength plate can have little or substantially no effect in the reflective mode.

FIG. 12B is a cross-sectional diagram illustrating an exemplary embodiment of a method operation in which the display apparatus of FIG. 11 displays a black color in the reflective mode. In the reflective mode, the switching mirror 24 is switched to transmissive state as the backlight unit 20 is turned off. Therefore, the method of operation shown in FIG. 12B can be substantially identical to the method of operation in the reflective mode described in FIGS. 2A and 2B.

According to an embodiment, an entire liquid crystal cell can be selectively used in either the transmissive mode or the reflective mode according to an intensity of external light. Thus, a brightness can be maximized without a decrease in resolution in either a transmissive mode or a reflective mode. Also, in an embodiment where a display apparatus is applied in a mobile LCD apparatus, a visibility of an image in an outdoor environment can be improved and a power consumption can be reduced. Furthermore, parallax in the reflective mode can be reduced or substantially eliminated by using a polarizing plate disposed within a cell structure. By disposing the diffusing plate and the polarizing plate as a single unitary body, an intensity of transmitted light can be increased and an intensity of reflected external light can be decreased. Moreover, by decreasing an intensity of light leaking from a reflective polarizing plate by using light collimated at a backlight unit, a CR in the transmissive mode can be increased. A diffusing plate, wherein a haze is different for different angles of incident light, can result in reduced image overlap in the reflective mode and a wider viewing angle in the transmissive mode.

What is claimed is:

1. A display apparatus including a plurality of pixels, each of the pixels comprising:
a first substrate;
a first polarizing plate on the first substrate;
a second substrate;
a liquid crystal layer disposed between the first substrate and the second substrate;
a second polarizing plate which is disposed between the first substrate and the second substrate, reflecting and transmitting external light or internal light;
a backlight unit irradiating the internal light and disposed under the second polarizing plate; and
a light absorbing layer disposed under the backlight unit,
wherein the plurality of pixels can be switched between one of a reflective mode in which an image is displayed using the external light and a transmissive mode in which an image is displayed using the internal light.

2. The display apparatus of claim 1, wherein a diffusing plate is disposed on the first polarizing plate.

3. The display apparatus of claim 2, wherein the diffusing plate contacts the first polarizing plate without an air layer interposed therebetween.

4. The display apparatus of claim 2, wherein an anti-reflection layer is further disposed on the diffusing plate.

5. The display apparatus of claim 1, wherein the second polarizing plate is disposed within the liquid crystal layer and within a cell structure.

6. The display apparatus of claim 1, further comprising a quarter wavelength plate disposed between the second polarizing plate and the backlight unit.

7. The display apparatus of claim 1, further comprising a reflective third polarizing plate disposed between the backlight unit and the light absorbing layer.

8. The display apparatus of claim 1, further comprising a switching mirror disposed between the backlight unit and the light absorbing layer.

9. The display apparatus of claim 8, further comprising a polarization converting layer disposed between the backlight unit and the switching mirror.

10. The display apparatus of claim 1, further comprising:
a first color filter layer disposed between the first polarizing plate and the liquid crystal layer; and
a second color filter layer disposed under the second polarizing plate.

11. The display apparatus of claim 2, wherein the diffusing plate has a haze value with respect to oblique incident light, which is greater than a haze value with respect to front incident light.

12. The display apparatus of claim 1, wherein the backlight unit irradiates focused internal light, wherein a brightness at full width at half maximum is plus or minus 20 degrees.

13. A pixel, comprising:
a first substrate;
a first polarizing plate on the first substrate;
a second substrate;
a liquid crystal layer disposed between the first substrate and the second substrate;
a second polarizing plate which is disposed between the first substrate and the second substrate, reflecting and transmitting external light or internal light;
a backlight unit irradiating the internal light and disposed under the second polarizing plate; and
a light absorbing layer disposed under the backlight unit,
wherein the pixel can be switched between one of a reflective mode in which the external light is reflected by the second polarization plate and a transmissive mode in which the internal light is transmitted through the second polarization plate.

14. The display apparatus of claim 1, wherein the liquid crystal layer electrically controls a transmissivity of incident light.

15. The display apparatus of claim 1, wherein the reflective mode comprises display of an image using the external light.

16. The display apparatus of claim 1, wherein the transmissive mode comprises display of an image using the internal light.

17. The display apparatus of claim 1, wherein the display apparatus can be switched between a reflective mode and a transmissive mode.

18. A method of displaying an image, the method comprising:
passing light through a first polarizing plate to form a first light having a first polarization;
selectively converting the first light having the first polarization to a second light having a second polarization;
reflecting the first light from a second polarizing plate if it has the first polarization; and
transmitting the second light having the second polarization through the second polarizing plate if the first light is converted to the second light having the second polarization.
